(19) United States
(12) Patent Application Publication
(10) Pub. No.: US 2007/0139362 A1
(43) Pub. Date: Jun. 21, 2007

(54) Health management system for personal computer users

(76) Inventors: James Colton, Bournemouth (GB); Simon Hardman, Knoxville, TN (US); Garry Sneddon, Shawlands (GB)

Correspondence Address: KNOX PATENTS, P.O. BOX 30034, KNOXVILLE, TN, 37930-0034, US

(21) Appl. No.: 11/300,897

(22) Filed: Dec. 15, 2005

(51) Int. Cl. G09G 5/00

(52) U.S. Cl. 345/156

(57) ABSTRACT

A monitoring and corrective action system for computer users. The system monitors the real-time interactions of a user with a computer workstation's keyboard, mouse, and video display unit to determine the strain induced in the user. The induced strain value also is based upon setting entered by the user indicating the users discomfort level, recovery level, and typing proficiency. The system provides feedback to the user to allow the user to modify behavior in order to reduce the induced strain. The feedback includes, in various embodiments, displaying safe-tips, displaying exercises, displaying real-time strain graphs, and forced breaks. The system also includes provisions for reporting induced strain levels and behavior patterns to others through electronic messages such as e-mail.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to a holistic health and disability management tool which calculates and manages computer user strain and targets specific physiological exercises to manage strain, as well as providing an overall methodology to identify users who are at risk of injury. More particularly, this invention pertains to software that is executed on a computer for monitoring the activities of a user in order to prevent, reduce, and/or correct strain induced by use of the computer.

2. Description of the Related Art

The increasing use of personal computers presents considerable health risks that have only been recently recognized. Various types of injuries are incurred by individuals from using personal computers for extensive periods of time and over extensive periods of time. For example, cumulative trauma (CT), musculoskeletal disorders (MSD's), occupational overuse syndrome (OOS), and repetitive strain injury (RSI) all describe injuries that result from performing repetitive tasks over extensive periods.

The physiological causes of repetitive strain injury can be summarized as the accumulation of: muscle tension, repetitive motion, overuse, and incorrect posture. To function properly, the body and each of its structures need a steady supply of blood that is rich in oxygen and nutrients. Cutting off or slowing the blood supply harms the tissues of the body. Tense muscles tend to squeeze off the flow of energy and fuel, both to the tense muscles and muscles located downstream. Muscles can get energy without oxygen; however, the process produces lactic acid, a potent pain causing chemical. As pain develops, muscles tighten further to guard or protect the surrounding area, thereby slowing the flow of blood even more. Nerves deprived of blood and squeezed by muscles begin to tingle or go numb. Repetitive movements applied to muscles and joints the same way all the time may contribute to early wear and tear. Also, over-using muscles and joints after they have become fatigued increases the likelihood of injury. Overloaded or without proper rest, muscles and joints have no chance to recover fully. Additionally, incorrect posture places stress on the body causing pain and stiffness. The body and its joints are made for movement, and even correct posture held for a long time becomes tiring.

Recent research has illustrated the additional danger of visual display unit (VDU) usage on the human eye. Older studies have identified a linkage to eye fatigue and general blurring combined with increased incidents of headaches associated with VDU usage. In 2004, the first medical evidence was published linking VDU usage with eyesight deterioration. The linkage between VDU usage and eyesight deterioration through the increased occurrence of glaucoma is one of the most serious medical findings in this field in recent years, since glaucoma can lead to clinical blindness.

From a medical and physiological perspective, the causal factors of muscle tension, repetitive motion overuse and incorrect posture are all affected to a some degree by the user. It is recognized that users, left to their own device, will not self-regulate to prevent or minimize problems created by improper use of computers and VDUs. Also, the very nature of these causal factors dictates that physical degradation to the micro-tendons has taken place before the pain manifests itself to the user, in effect, when the user is aware of the need to take a break, it is too late.

Furthermore, by managing these causal factors, not only are injuries prevented, but, also, existing injuries can be managed and injuries that have resulted in a permanent or semi-permanent disability can also be managed to allow the user to interact with a computer, thereby increasing quality of life. In the case of immobilized individuals, the Internet is often their main access point to the outside world. However, in providing a health and wellness benefit to these different groups of users, it must be recognized that individual factors must be considered for any given system to truly manage health and disabilities.

### BRIEF SUMMARY OF THE INVENTION

According to one embodiment of the present invention, a system for monitoring computer usage of an individual and providing feedback for corrective action is provided. A software program running in the background monitors user inputs and outputs to determine an induced strain value. Feedback is presented to the user when the induced strain value reaches or exceeds specified values. In various embodiments, the feedback includes safe-tips, which are pop-up messages, exercises, and breaks.

The system provides a health and personal wellness solution that encompasses strategies for the pro-active prevention of injuries, the rehabilitation of existing injuries, and the management of disabilities for computer users in all areas including personal, educational (primary and secondary), governmental, and business users. The system provides preventative measures and also acts as a reporting tool for an occupational health department to enable company resources to be targeted at those users who most need preventative and rehabilitation services.

The system takes into account human factors and task related factors. In one embodiment, the human factors are summarized by values input by the user. These values include the degree of discomfort as perceived by the user, the time normally taken to recover when discomfort is experienced, and the users typing style and proficiency. By determining certain causal factors humanistic, task and environmental factors, a model of a persons strain is compiled. It is likely that these factors may change over time, thus influencing the strain model; therefore, the model is computed in real time to be meaningful and present current, up-to-date information relating to the user's induced strain.

By accurately modeling strain, a pro-active strategy is determined to manage the user's strain via work breaks and physiological exercises that minimize the risk of injury, aid rehabilitation, or enable a user to work safely by managing their strain to prevent the aggravation of a disability. Since the nature of cumulative trauma type injuries is the accumulation of micro-trauma's over time, after a historical picture of a user's behavior is built, a predictive model is built of users who are at risk.

Based on data of the users' perceived discomfort and recovery time and based on the user's usage patterns, strategies are employed within the system and within the occupational health department to maximize users health, by an integrated program of work-breaks, physiological exercises, and eye breaks, combined with occupational health measures such as physiotherapy.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a pictorial view of a user at a computer workstation;

FIG. 2 is a simplified block diagram of the monitoring and corrective action system;

FIG. 3 is a functional block diagram of one embodiment of the system;

FIG. 4 is a block diagram of one embodiment of the hardware and software functions of the system;

FIG. 5 is a block diagram of one embodiment of the analytical engine;

FIG. 6 is a block diagram of one embodiment of the take corrective action function; and

FIG. 7 is a block diagram of one embodiment of the various engines.

### DETAILED DESCRIPTION OF THE INVENTION

A system for monitoring computer usage by a user, determining a stress level, and offering corrective action when that stress level reaches predetermined levels is disclosed. Various factors are considered by the system, including the humanistic factors, task factors, and the environment.

With respect to the humanistic factors, every user has a unique strain profile, which can change over time and can change due to life events (such as car crash injury). The strain profile is not fixed, but can changes over time giving rise to different human states: healthy, at-risk, injured, in rehabilitation, and disabled. The intensity and frequency of discomfort that a user experiences is a key indicator in determining the frequency of breaks that are required to prevent tissue/tendon damage. The time taken for a user to recover from experiencing discomfort is another key indicator in determining the length of the breaks and in modeling the user's strain recovery rates, which regulate the speed at which the user's strain naturally falls (similar to cardiovascular recovery). A user's typing proficiency is one of the most important definable variables in determining how the level of the user's input (i.e. the intensity of their typing) affects the degree of strain that the user experiences, for example, a touch typist can make more key strokes per minute with less resultant strain than a hunt and peck typist.

With respect to the task factors, the time spent in a static position, the repetitive motions made whilst in a static position on a continuous basis (i.e., no break), and the time spent with eyes focused at a constant distance on a continuous basis affect the strain induced in a user.

With respect to the environment, the primary variable is the work station configuration. The degree to which an environment follows ergonomic principles impacts the level of induced strain. Given two users with identical human and task characteristics and given two different workstation designs, the user with the ergonomically designed workstation will have a lower perceived value of discomfort, that is, the user experiences less discomfort intensity and frequency. Thus, the key environmental factor is taken account of, albeit indirectly. Other environmental variables, such as of stress, temperature, and noise also impact induced strain, but are of less significance than the other factors identified above.

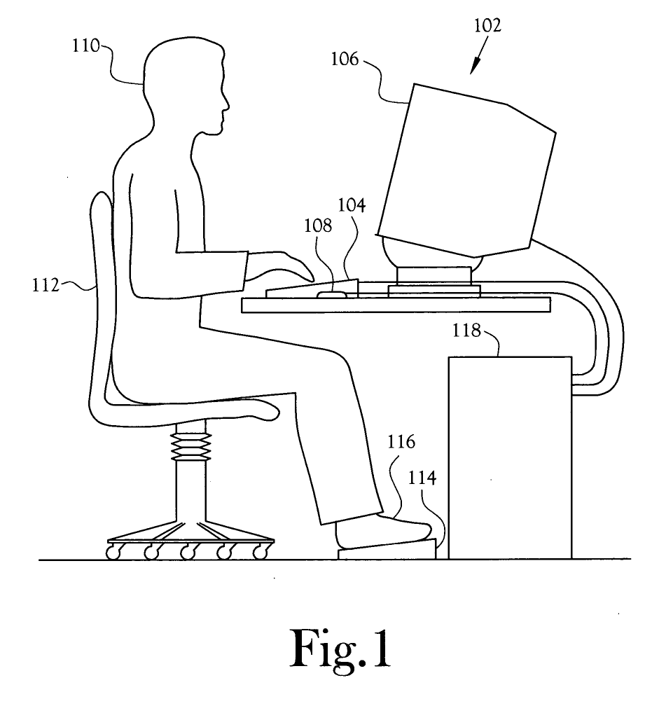

FIG. 1 illustrates a pictorial view of a user 110 at a computer workstation 102. The computer user 110 is seated in a chair 112 with the user's feet 116 positioned on a foot rest 114. The computer workstation 102 includes a keyboard 104, a mouse 108, a video display unit (VDU) 106, and a computer 118.

As used herein, the computer 118 should be broadly construed to mean any computer or component thereof that executes software. The computer 118 includes a memory medium that stores software, a processing unit that executes the software, and input/output (I/O) units for communicating with external devices, such as the keyboard 104, the mouse 108, and the VDU 106. Those skilled in the art will recognize that the memory medium associated with the computer 118 can be either internal or external to the processing unit of the computer 118 without departing from the scope and spirit of the present invention.

In one embodiment the computer 118 is a general purpose computer, in another embodiment, it is a specialized device, such as a graphics workstation, that also includes the various functions of the invention. Those skilled in the art will recognize that the computer 118 includes an input component, an output component, a storage component, and a processing component. The input component receives input from external devices, such as the keyboard 104 and the mouse 108. The output component sends output to external devices, such as the VDU 106. The storage component stores data and program code. In one embodiment, the storage component includes random access memory. In another embodiment, the storage component includes non-volatile memory, such as floppy disks, hard disks, and writeable optical disks. The processing component executes the instructions included in the software and routines.

In various embodiments, the monitoring and corrective action system 100 is installed and accessed locally in the computer 118 or is accessed and executed remotely by the computer 118 accessing a network server such as found in a local area network (LAN) or on the Internet. In the embodiment in which the monitoring and corrective action system 100 is installed locally at the computer 118, the system 100 can be installed manually or automatically through the LAN or other network connection, from either an installation disk or a remote copy.

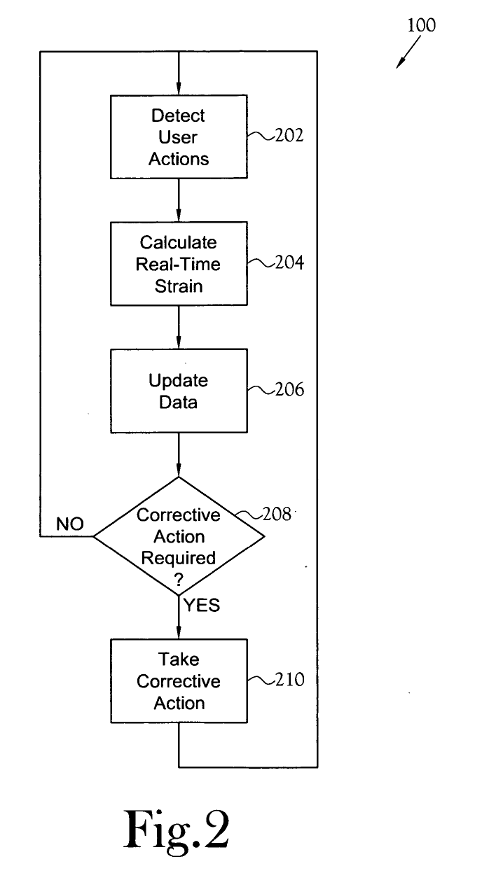

FIG. 2 illustrates a simplified block diagram of the monitoring and corrective action system 100. The system 100 detects user actions 202, such as typing on the keyboard 104, moving and clicking the mouse 108, reading the VDU 106, or not using the computer workstation 102 at all. After the user actions are detected 202, the system 100 calculates a value of real-time strain 204. The calculated value is then used to update data 206. The current strain value and the data are used to determine if corrective action is required 208. If no corrective action is required 208, then the loop repeats at the first step of detecting the user actions 202. If corrective action is required 208, then corrective action is taken 210 and the loop repeats at the first step of detecting the user actions 202. Corrective action includes, in various embodiments, displaying safe tips on the DVU 106, displaying warnings on the DVU 106, displaying exercises on the DVU 106, displaying a message to take a break on the DVU 106, and/or locking the user 110 out of the workstation 102 for a specified period.

The step of detecting user actions 202 provides data related to the how the user 110 is currently using the workstation 102. A user 110 typically uses a workstation 102 to enter data, such as by typing and moving/clicking the mouse, and to navigate and read documents and data on the VDU 106. The first use, typing and moving/clicking the mouse, is active use, as compared to the second use of reading documents and data, which is a passive use. There is a third state of action of the user 110 that is idle, which is the user 110 not interacting with the workstation 102 at all.

The active state is indicated by the user 110 typing on the keyboard 104 and/or moving and clicking the mouse 108 occurring with a specified frequency over a specified period of time. The active state includes the user 110 viewing the VDU 106. For example, a user 110 who is typing a letter is in the active state. The user 110 may pause for a short period of time to confirm an address or check spelling, but, in general, the activity of typing the letter puts the user 110 in the active state. Strain is induced in the user 110 during the active state by such factors as muscle strain from repetitive motions at the keyboard 104 and mouse 108, eye strain from viewing the VDU 106, and general strain on the musculoskeletal system from being in a stationary position.

The passive state is indicated by less frequent typing on the keyboard 104 and movement and clicking of the mouse 108, or by changes to the content displayed on the VDU 106. For example, a user 110 who is reading a document on the VDU 106 is in the passive state. Typically, occasional operation of the navigation keys on the keyboard 104, such as the page up, page down, and the cursor keys, indicates the passive state. Also, changes to the content displayed on the VDU 106, such as display of a video or scrolling of text, indicates that the user 110 is viewing or reading content on the VDU 106, and, accordingly, in the passive state. Strain is induced in the user 110 during the passive state by such factors as eye strain from viewing the VDU 106, and general strain on the musculoskeletal system from being in a stationary position. However, strain is also reduced because of the reduction of repetitive motions at the keyboard 104 and mouse 108.

The idle state is indicated when there is no typing on the keyboard 104 or movement or clicking of the mouse 108 for a specified period of time. For example, if the user 110 does not use the workstation 102 for a specified period of time, there will be no typing on the keyboard 104 and/or movement and clicking of the mouse 108 occurring over that period of time. Also, another indication of the idle state is when the content of the VDU 106 does not change for a specified period of time. Such an example of the idle state is when the VDU 106 screen saver program is executed. Strain is reduced in the user 110 during the idle state because of the reduction of the repetitive motions at the keyboard 104 and mouse 108, the eye strain from viewing the VDU 106, the and general strain on the musculoskeletal system from being in a stationary position.

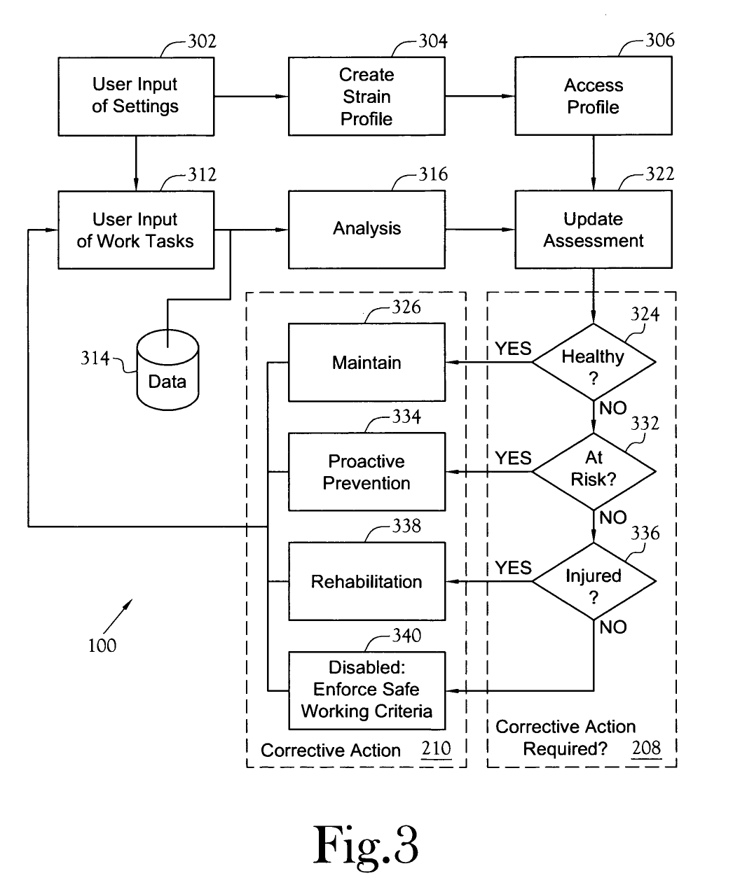

FIG. 3 illustrates a functional block diagram of one embodiment of the system 100. Initially, the user 110 inputs settings 302 identifying specific information related to the user 110. In one embodiment, the input of settings 302 is accomplished by the user 110 accessing a graphical user interface (GUI) displayed on the VDU 106. After the user inputs the settings 302, the user settings are used to create a strain profile 304 for that user 110. After the strain profile is created 304, the next steps are to assess the profile 306 and to update the strain assessment 322 to determine management strategy to apply to that user 110.

In one embodiment, the create strain profile 304 determines a strain profile, or an injury risk profile, with the following equation:
injury risk profile=injury_risk*risk_reduction
where injury_risk=((discomfort+average_strain)/2)*usage

where discomfort is the value of discomfort entered by the user 110;
average_strain is the average value of induced strain over a specified period; and
usage is a factor based on how often the user 110 is in the active, passive, and idle state; and
   risk_reduction=1−(break_compliance/2)

where break_compliance is a factor determined by the measure break compliance routine 608, where the factor is a percentage of compliance to initiated breaks.

After the user inputs the settings 302, the system 100 monitors the user input of work tasks 312. Additionally, in one embodiment, the user input of settings 302 is considered a work task and provides strain data for the user input of work tasks 312. The data collected during the input of work tasks 312 is stored in a data storage unit 314.

Work tasks include any and all interactions of the user 110 with the software running on the workstation 102. Such software includes word processors, text editors, spreadsheets, database programs, and browsers, among a multitude of other software and programs that users 110 interact with on the workstation 102. The user 110, in interacting with such software, necessarily uses the keyboard 104 and/or the mouse 108, along with the VDU 106. In various embodiments, the interaction details, such as which keys are pressed and for how long, how much the mouse 108 has moved and/or been clicked in a time period, and how much the display on the VDU 106 has changed, make up the data that is collected during the input of work tasks 312. The purpose of the system 100 is to determine the induced strain of the user as the workstation 102 is operated by the user 110 performing normal, computer related tasks. These normal, computer related tasks are the work tasks referred to herein.

The data from the input of work tasks 312 and the data stored in the data storage unit 314 are then analyzed 316 to determine the real-time accumulated strain of the user 110. The results of the analysis 316 are used to update the assessment 322. After the assessment is updated 322, the updated assessment results are reviewed to determine if corrective action is required 208. The determination of whether corrective action is required 208 includes determining if the user 110 is healthy 324, at risk 332, injured 336, or disabled 340. The corrective action 210 taken is determined from the results of the step of whether corrective action is required 208. If the user 110 is determined to be healthy 324, then the system 110 allows the user 110 to maintain 326 using the workstation 102. If the user 110 is determined to be at risk 332, then proactive prevention 334 is taken. If the user 110 is determined to be injured 336, then rehabilitation 338 is taken. If the user 110 is determined to be not healthy 324, not at risk 332, and not injured 336, then the user 110 is assessed to be disabled and the safe working criteria are enabled 340. After maintaining 326, proactive prevention 334, rehabilitation 338, or enabling safe working 340, the user input of work tasks 312 continues.

In one embodiment, the user input of settings 302 includes the user 110 entering values for discomfort, RSI_threshold, recovery, and proficiency. In another embodiment, the user input of settings 302 includes the user 110 entering administrative settings, such as, disabling the display of safe-tips and break warnings, setting average safe-tip display times, displaying a splash screen, and other administrative type settings. In one such embodiment, the user 110 has administrative privileges and the input of settings 302 includes specific heath profiles, for example, healthy, at-risk, rehabilitation, disabled, and settings to restrict the degree of choice a non-administrative privilege user 110 has. Typically, the administrative privileged user 110 is a member of a company's occupational health department.

In one embodiment, the value for discomfort is entered by the user 110 who is presented with a slider graphic and is asked to answer the question “How often do you experience physical discomfort?” by moving the slider from “Rarely” to “Frequently.” As the slider moves, the user 110 is presented with text corresponding to the various discomfort levels. In one embodiment, the text statements include perfectly healthy and no, isolated, occasional, regular, continual, and severe problems.

The value for RSI_threshold is entered by the user 110 who is presented with a slider graphic and is asked to provide the threshold level of repetitive stress injury that the user 110 is susceptible to. In other embodiments, the RSI_threshold is the same as or based upon the discomfort value.

The value for recovery is entered by the user 110 who is presented with a slider graphic and is asked to answer the question “How fast is your recovery from a typical work-related strain?” by moving the slider from “Shorter” to “Longer.” As the slider moves, the user 110 is presented with text corresponding to the various recovery levels. In one embodiment, the text statements include very fast, fast, moderate, and quite, very, extremely, painfully slow.

The value for proficiency is entered by the user 110 who is presented with a slider graphic and is asked to answer the question “What is your typing proficiency?” by moving the slider from “Novice” to “Expert.” As the slider moves, the user 110 is presented with text corresponding to the various proficiency levels. In one embodiment, the text statements include slow ‘peck and hunt;’ fast ‘peck and hunt;’ reasonable usage of 4 or fingers; fast, untrained; touch-typist; proficient touch-typist; and highly trained touch-typist.

In various embodiments, the step of maintain 326 includes either allowing the user 110 to continue without intervention or by scheduling breaks, presenting safe-tips, and/or presenting exercises. Scheduling breaks allows the user 110 to continue to work without increasing strain beyond an acceptable level. The breaks allows the muscles and other body structures of the user 110 to relax and recuperate so that work can continue. The safe-tips are, in one embodiment, pop-up messages presented for viewing on the VDU 106. The safe-tips include messages on correct posture, such as sitting up straight; hints to relieve stress, such as looking away from the VDU 106 for a few seconds; and other messages that serve to relieve strain and/or stress in themselves or by outlining some action that can be taken by the user 110. The exercises presented include simple physiological exercises that are known to prevent the accumulation of strain and/or relieve any accumulated strain.

In various embodiments, proactive prevention 334 includes scheduling breaks, presenting safe-tips, and/or presenting exercises. The corrective action provided under proactive prevention 334 is aimed at those users 110 whose use of the workstation 102 is at the level where strain is reaching, but has not yet reached, the level of injury. The number and length of the breaks, the safe-tips, and the presented exercises are geared more towards relieving strain and/or stopping the accumulation of strain. For example, the user 110 may be asked to perform an exercise of standing up and stretching in a particular manner.

In various embodiments, rehabilitation 338 includes scheduling breaks, forcing work breaks, and/or presenting rehabilitative exercises. The corrective action provided under rehabilitation 338 is aimed at those users 110 whose use of the workstation 102 is at the level where the strain level indicates that there is injury of some type occurring to some body portion of the user 110. Breaks under rehabilitation 338 are more frequent and longer, and in some embodiments, may be forced whereby the workstation 102 prevents the user 110 from performing any work tasks with the workstation 102. The rehabilitative exercises presented include those suitable for rehabilitation of specific body parts, such as the wrist, arm, and neck, among others.

In various embodiments, enforcing safe working criteria 340 includes scheduling breaks, forcing work breaks, presenting safe-tips, presenting exercises, and/or locking the user 110 out of using the workstation 102. The corrective action provided under disabled: enforce safe working criteria 340 is aimed at those users 110 who are shown to be disabled and not capable of high levels of strain. The corrective action performed under enforcing safe working criteria 340 is tailored to accommodate the special needs of the disabled and to ensure that the disability is not aggravated by the user's work habits.

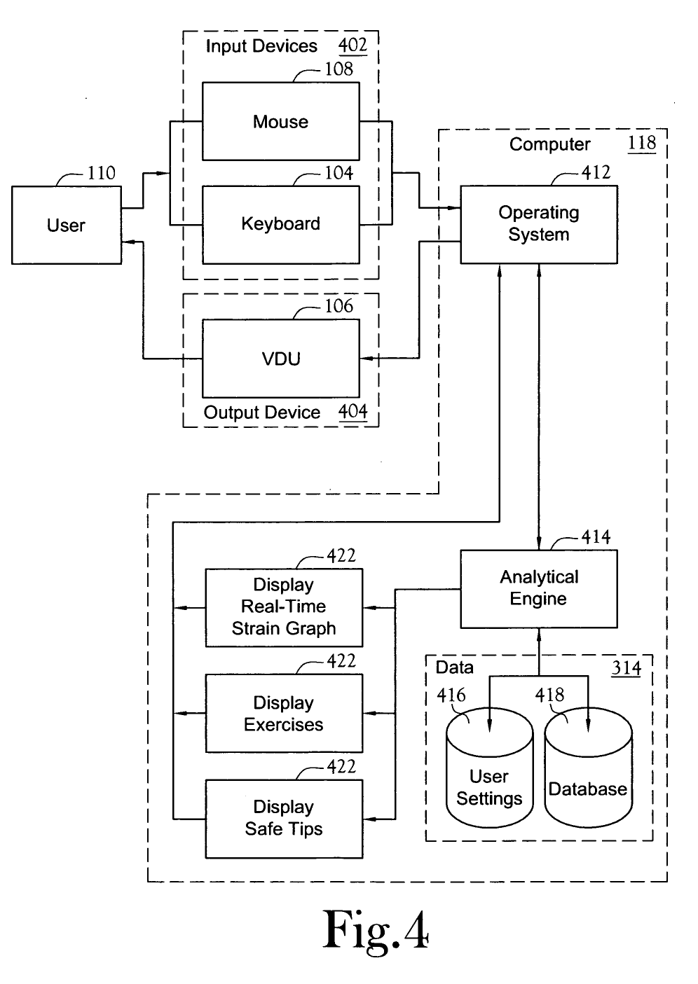

FIG. 4 illustrates a block diagram of one embodiment of the hardware and software functions of the system 100. The user 110 interacts with the input devices 402 and the output devices 106. In various embodiments, the input devices 402 include a keyboard 104, a mouse 108, and/or other types of input devices such as a joystick, a trackball, and a thumbball, among others. In one embodiment, the output devices 404 includes a VDU 106, such as a cathode ray tube monitor or a liquid crystal display (LCD). In other embodiments, the output devices 404 includes a printer or other output device. The input devices 402 and the output devices 404 are connected to the computer 118.

The input devices 402 and the output devices 404 communicate with the operating system 412 of the computer 118. The operating system is a program that allows the various hardware components of the computer 118 to function, such as Microsoft Windows. Likewise, the software and routines of the present invention communicate with the operating system 412 in order to access the input and output devices 402, 404.

The analytical engine 414 is a software program executed by the processor in the computer 118 and the engine 414 runs in the background, continually monitoring the user input of work tasks 312. The analytical engine 414 includes, among others, the software routines for calculating the real-time strain 204, updating the data 206, and determining whether corrective action is required 208. The analytical engine 414 communicates with the data storage unit 314, which, in one embodiment, includes data storage for the user settings 416 and data storage for other data 418, such as the data related to the user input of work tasks 312.

A routine for displaying a real-time strain graph 422 receives input from the analytical engine 414 to display graphs on the VDU 106. In one embodiment, the display of a real-time strain graph 422 includes showing a graphical representation of induced strain on a chart with the x-axis indicating time and the y-axis indicating strain level. In other embodiments, displaying the real-time graph 422 includes information on the number of key presses on the keyboard 104, then number of clicks and/or the amount of movement of the mouse 108, the current work session elapsed time, and/or the amount of energy expended by the user 110. Other routines for displaying exercises 424 and safe-tips 426 receive inputs from the analytical engine 414.

In various embodiments, the display of exercises 424 includes presenting on the screen of the VDU 106 a text-based description and an accompanying video or animated graphic displaying the execution of the exercise. The exercises are typically short, simple movements

Safe-tips are short messages that provide helpful hints and tips for the user 110 on various aspects of preventing and rehabilitating workstation induced strain. In one embodiment, the display of safe-tips 426 occurs at random, but frequent intervals in a pop-up window that disappears from the screen of the VDU 106 after a specified period. In another embodiment, the user 110 actively selects an option to display a safe-tip on the screen of the VDU 106.

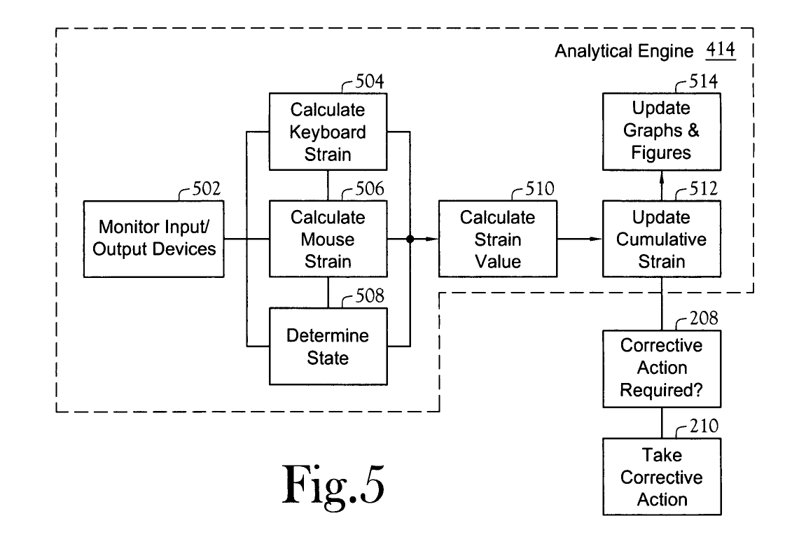

FIG. 5 illustrates a block diagram of one embodiment of the analytical engine 414. The analytical engine 414 performs various functions and routines, including monitoring the input/output devices 502 for changes. These changes include typing on the keyboard 104, moving and clicking the mouse 108, and content changes displayed on the VDU 106. The monitoring input/output devices routine 502 provides input to the calculate keyboard strain routine 504, the calculate mouse strain routine 506, and the determine state routine 508. These three routines 504, 506, 508 provide input to the calculate strain value routine 510. The output of the calculate strain value routine 510 is used by the update cumulative strain function 512. The output of the update cumulative strain function 512 is used to update the graphs and figures 514 and by the corrective action required ? routine 208, which communicates with the tak corrective action routine 210.

The routine to monitor the input/output devices 502 includes monitoring for keystrokes, mouse 108 movements, mouse 108 clicks, and the state of the user 110. This routine 502 interacts with the operating system 412 to capture the information without affecting the applications being accessed by the user 110. With respect to the keystrokes monitored, in one embodiment, the routine 502 identifies the specific keystrokes made and the order and timing of the keystrokes. With respect to the mouse 108 movements, in one embodiment, the routine 502 identifies the change in movement based on each frame based on a two-dimensional vector. A frame is a change instate as determined by the operating system 412. With respect to the mouse 108 clicks, in one embodiment, the routine 502 identifies the number of clicks made.

In one embodiment, the calculate keyboard strain routine 504 is executed for each keystroke of the keyboard. The routine to calculate keyboard strain 504, in one embodiment, uses the following equation:
keyboard_strain=current_strain*(1−(t_{elapsed}/recovery)²)

where keyboard_strain is the value of strain induced by use of the keyboard 104 since the last iteration of the calculate keyboard strain routine 504;
current_strain is the value as calculated by the equation shown below;
t_{elapsed} is the elapsed time in seconds since the last iteration of the calculation of keyboard strain routine 504; and
recovery is the value of recovery entered by the user 110.

The value of current_strain is determined by the following equation:
current_strain=(movement*k1)*weight*discomfort*proficiency

where current_strain is the value corresponding to a single key press;
movement is the change in movement by the user 110 and is determined from the distance between the previous key stroke and the current key stroke and the force of the key press, which is determined by the amount of time that the key was depressed;
k1 is a constant to normalize the units, such as 0.001;
weight is the weight of the arm of the user 110, for example, 2.5 kg;
discomfort is the value of discomfort entered by the user 110; and
proficiency is the value of proficiency entered by the user 110.

In various embodiments, the t_{elapsed} variable is based on ticks. In computers, time is often measured by ticks, and elapsed time is often expressed in terms of ticks calculated by subtracting a starting value of a counter register from the current value of the counter register, giving the difference between the two values, which corresponds to a period of time. A tick is an increment of the value of the counter register, and the counter register is incremented at a regular rate by the operating system 412 or another routine. For example, in some operating systems, a tick is 100 nanoseconds, that is, 10,000,000 ticks represent one second.

In one embodiment, the calculate mouse strain routine 506 is executed periodically, that is, the routine 506 is executed at specific time intervals. The routine to calculate mouse strain 506, in one embodiment, uses the following equation:
mouse_strain=(dₓ²+d_{y}²)^{1/2}/t_{elapsed})*RSI_threshold+k2

where mouse_strain is the value of strain induced by use of the mouse 108 since the last iteration of the calculate mouse strain routine 506;
dₓ is the change in position of the mouse 108 along the x-axis;
d_{y} is the change in position of the mouse 108 along the y-axis;
t_{elapsed} is the elapsed time in seconds since the last iteration of the calculate mouse strain routine 506;
RSI_threshold is the value of RSI_threshold determined from the user settings; and
k2 is a constant to normalize the units, such as 850.

In another embodiment, the routine to calculate mouse strain 506 uses the following equation:
mouse_strain=notches*(RSI_threshold/k3)

where notches is the number of units tracked by the operating system 412 corresponding to the movement of the mouse 108;
RSI_threshold is the value of RSI_threshold determined from the user settings (in one embodiment, RSI_threshold is entered by the user 110 during the user input of settings 302; and
k3 is a constant to normalize the units, such as 250.

The routine to determine state 508, in one embodiment, determines that the current state is the active state if there has been a specified number of keys pressed on the keyboard 104 and/or if there has been a specified amount of mouse 108 movement or a specified number of mouse clicks within a specified period. The routine 508 determines that the current state is the idle state if the current state is not the active state and there has been no change to the content displayed on the VDU 106 within a specified period. In one embodiment, the routine 508 determines that the current state is the passive state if the current state is not the active state and the current state is not the idle state. In another embodiment, the routine 508 determines that the current state is the passive state if the current state is not the active state and the content of the monitor has changed within a specified period.

The routine to calculate the strain value 510, in one embodiment, uses the following equation:
strain=keyboard_strain+mouse_strain

where strain is the total calculated strain value;
keyboard_strain is the value calculated by the calculate keyboard strain routine 504; and
mouse_strain is the value calculated by the calculate mouse strain routine 506.

In one embodiment, the update cumulative strain routine 512 determines an induced strain value that represents the strain experienced by the user 110 both at the current time (as determined by the calculate strain value routine 510) and for the time immediately preceding the current time. For example, a user 110 typing for an extended period of time will have a greater value of induced strain because the strain induced prior to one point in time has not been alleviated before the user 110 induces additional strain by the current typing. The update cumulative strain function 512 considers the recovery value entered by the user 110 to regulate the rate at which the induced strain falls and the time since the last passive and/or idle state.

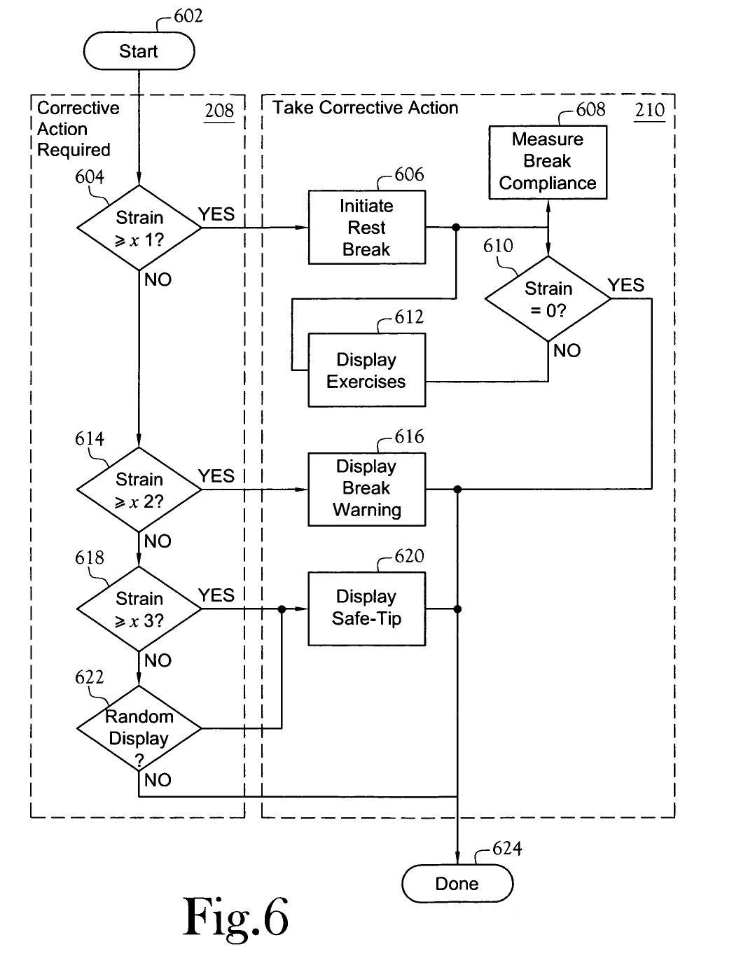

FIG. 6 illustrates a block diagram of one embodiment of the corrective action required routine 208 and the take corrective action routine 210. The corrective action required routine 208 starts 602 with the updated induced strain value determined by the update cumulative strain routine 512 illustrated in FIG. 5. The induced strain value is checked 604, 614, 618, in the illustrated embodiment, at three different levels x1, x2, x3. The results of the checks 604, 614, 618 are passed to the take corrective action routine 210, which performs the corrective action indicated by the value of the updated induced strain value.

The first check of the induced strain value is whether the strain is greater than or equal to a first specified value x1. In one embodiment, the first specified value x1 is 100% of a normalized value of induced strain, although the value of the specified value x1 can vary to meet the needs of the user 110 and as determined by other variables. If the induced strain value is greater than or equal to a specified value x1, then a rest break is initiated 606. After the rest break is initiated 606, the next step is to measure break compliance 608. In conjunction with measuring break compliance 608, the induced strain value is checked 610, and if it is not zero, then exercises are displayed 612 on the VDU 106. After displaying the exercises 612, the strain is checked 610 again. If, after checking, the strain is zero 610, then the take corrective action routine 210 is done 624.

The second check 614 of the induced strain value is whether the strain is greater than or equal to a second specified value x2. In one embodiment, the second specified value x2 is 90% of a normalized value of induced strain, although the value of the second specified value x2 can vary to meet the needs of the user 110 and as determined by other variables. If the induced strain value is greater than or equal to the second specified value x2, then a break warning message is displayed 616 on the VDU 106.

The third check 618 of the induced strain value is whether the strain is greater than or equal to a third specified value x3. In one embodiment, the third specified value x3 is 80% of a normalized value of induced strain, although the value of the third specified value x3 can vary to meet the needs of the user 110 and as determined by other variables. If the induced strain value is greater than or equal to the third specified value x3, then a safe-tip is displayed 620.

If no other corrective action is indicated 604, 614, 618, then the corrective action required routine 208 determines if it is time for a random display 622 of a safe-tip. If it is, then a safe-tip is displayed 620. In one embodiment, the user 110 has the option to disable the random display sub-routine 622.

In various embodiments, one or more of the first, second, and/or third check 604, 614, 618 are not performed. In other embodiments, the user 110 is offered the option to exit or ignore the initiated rest break 606 and/or to disable the display of break warnings 616 and safe-tips 620.

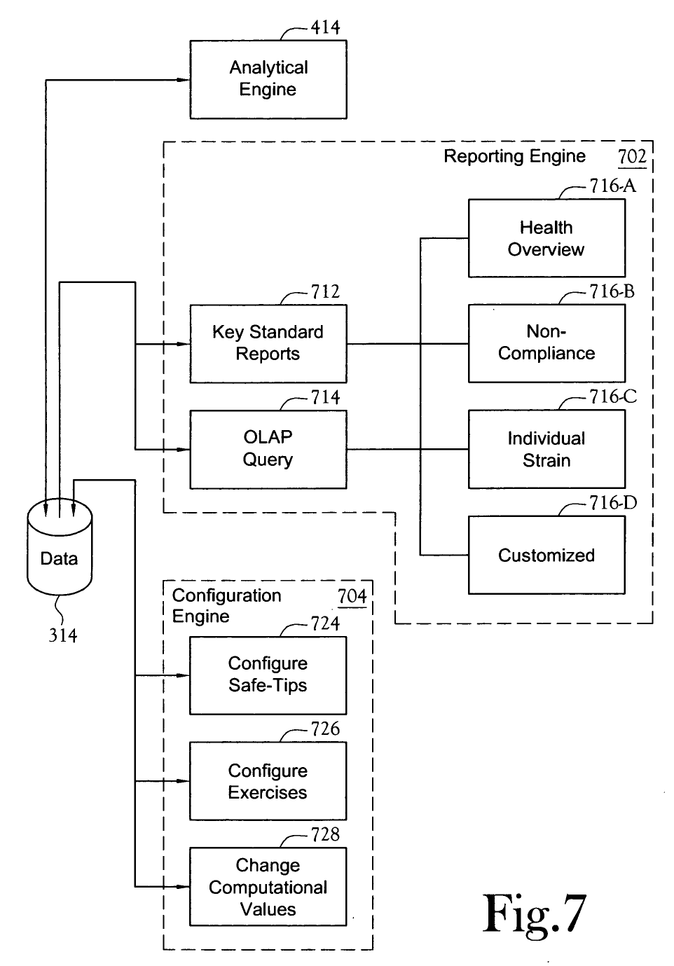

FIG. 7 illustrates a block diagram of one embodiment of the various engines 414, 702, 704. As described with respect to FIG. 4, the analytical engine 414 communicates with the data storage unit 314, both to store and retrieve data. The analytical engine 414 is in communication with the reporting engine 702, which also retrieves data from the data storage unit 314. The reporting engine 702 includes key standard reports 712 and OLAP (on-line analytical processing) query reports 714, both of which produce a variety of reports 716. One such report is the health overview report 716-A, which provides an overview of the health, as determined by the system 100, to the user 110. Another report is the non-compliance report 716-B, which provides information on the compliance of the user 110 to required breaks. A third report is the individual strain report 716-C, which provides information on the induced strain over time for a user 110. Also, customized reports 716-D are available to report on various items.

Also communicating with the data storage unit 314 is the configuration engine 704. The configuration engine 704 includes a configure safe-tips routine 724 and a configure exercises routine 726. In one embodiment, the safe-tips and exercises are stored in XML files, which require configuration and maintenance. The configuration engine 704 also includes a routine to change computational values 728. In various embodiments, the computational values include such values as the various specified values x1, x2 and/or the various constants k in the calculated equations.

In one embodiment, each of the functions identified in the various figures are performed by one or more software routines executed by the computer 118. In another embodiment, one or more of the functions identified are performed by hardware and the remainder of the functions are performed by one or more software routines run by the computer 118. In still another embodiment, the functions are implemented with hardware, with the computer 118 providing routing and control of the entire integrated system 100.

The computer 118 executes software, or routines, for performing various functions. These routines can be discrete units of code or interrelated among themselves. Those skilled in the art will recognize that the various functions can be implemented as individual routines, or code snippets, or in various groupings without departing from the spirit and scope of the present invention. As used herein, software and routines are synonymous. However, in general, a routine refers to code that performs a specified function, whereas software is a more general term that may include more than one routine or perform more than one function.

While the methods disclosed herein have been described and shown with reference to particular steps performed in a particular order, it will be understood that these steps may be combined, sub-divided, or re-ordered to form an equivalent method without departing from the teachings of the present invention. Accordingly, unless specifically indicated herein, the order and grouping of the steps is not a limitation of the present invention.

The humanistic factors of level of discomfort, recovery time from discomfort, and typing style, which are input by the user 302 are used by the monitoring and corrective action system 100 when the user makes inputs of work tasks 312, which includes keying and mouse 108 input, as well as changes to the VDU 106. The system 100 calculates the induced strain based on these individual settings, combined with the keyboard 104 and mouse 108 activity by the user 110. The induced strain is a dynamic variable calculated in real time, taking into account any natural pauses during the working day. When the strain reaches a pre-determined level x2, the system 100 will warn the user 100 that the user 110 will have to take a work-break soon based on the user's rate of activity, thereby allowing the user 110 to finish their current task before taking a break. If the user 110 continues, the system 100 prompts the user 110 to take a break until the strain has reduced below a predetermined level x2 and, in one embodiment, will suggest physiological exercises to be performed by the user 110 to reduce the user's strain level. These exercises, in one embodiment, are targeted towards certain areas based on the user's history of injury and discomfort. The user 110 has the option to trigger the display of these exercises at any time.

The monitoring and corrective action system 100 also ensures good ergonomic practice by displaying safe tips 622, which appear randomly throughout the working day. These safe tips provide reminders on all ergonomic aspects such as posture, monitor position, and chair & desk position, as well as reminding the user 110 takes eye-breaks every twelve minutes.

The data and information relating to the user's 110 keyboard 104 and mouse 108 usage, the user's 110 compliance to breaks, and the changes to the user's 110 individual settings are stored in the data storage unit 314. In one embodiment, the data regarding a user 110 is sent via an e-mail or other messaging system to another computer. The transfer of data allows the user 110 specific data to be used to predict a “at risk of injury” population by analyzing average strain, intensity of keyboard 104 usage and perceived discomfort by the users 110 and to generate a risk score. The risk score allows a company's occupational health department to develop pro-active wellness strategies, targeting the “at-risk population” to prevent injury through early intervention.

From the foregoing description, it will be recognized by those skilled in the art that a monitoring and corrective action system 100 for computer users has been provided. The system 100 monitors in real-time the user's interactions with a workstation 102 to determine the strain induced in the user 110. The system 100 monitors the keyboard 104, the mouse 108, and the changes on the VDU 106 over time to determine an induced strain value. The system 100 also provides feedback to the user 110 to allow the user 110 to modify behavior to reduce the induced strain.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A method in a computer system for monitoring and providing feedback to a user of a computer workstation, said method comprising the steps of:
providing for accepting input of a plurality of user specific settings to the computer workstation;
providing for storing said plurality of user specific settings;
providing for monitoring a plurality of inputs of the user from at least one input device selected from a group consisting of a keyboard and a mouse, said plurality of inputs entered as a part of a work task of the user;
providing for determining a strain value, said strain value being a real-time value corresponding to a strain induced in the user by operating the computer workstation;
providing for determining whether a corrective action is required based on said strain value, said corrective action selected from a group comprising displaying a safe-tip, displaying an exercise, and scheduling a break; and
providing for taking such said corrective action if determined to be required.

2. The method of claim 1 further including the step of providing for monitoring an output for changes to be viewed by the user of the computer workstation.

3. The method of claim 1 wherein said step of providing for determining said strain value further includes the step of providing for determining a keyboard strain value.

4. The method of claim 1 wherein said step of providing for determining said strain value further includes the step of providing for determining a keyboard strain value based on a current strain value multiplied by a first factor including an elapsed time divided by a recovery factor based on at least one of said plurality of user specific settings, said current strain based on a value corresponding to a distance of movement of the user multiplied by a second factor including a discomfort level based on least one of said plurality of user specific settings and multiplied by a third factor including a proficiency level based on least one of said plurality of user specific settings.

5. The method of claim 1 wherein said step of providing for determining said strain value further includes the step of providing for determining a mouse strain value.

6. The method of claim 1 wherein said step of providing for determining said strain value further includes the step of providing for determining a mouse strain value based on a distance of mouse movement divided by an elapsed time value and multiplied by a threshold value based on least one of said plurality of user specific settings.

7. The method of claim 1 wherein said step of providing for determining said strain value further includes the step of providing for combining a keyboard strain value and a mouse strain value.

8. The method of claim 1 wherein said step of providing for the user to input said plurality of user specific settings includes the step of providing for inputting a discomfort level, a recovery level, and a typing proficiency level.

9. A computer system for monitoring and providing feedback to a user of a computer workstation, said computer system comprising:
a keyboard for inputting text;
a mouse for interfacing with a graphical user interface;
a video display unit for presenting said graphical user interface to the user; and
a workstation having a processor and a memory component, said workstation in communication with said keyboard, said mouse, and said video display unit, said processor executing a process including
monitoring a plurality of inputs of the user from said keyboard and said mouse;
determining a strain value, said strain value being a real-time value of strain induced in the user by interfacing with said keyboard and said mouse; and
determining whether a corrective action is required based on said strain value;
taking said corrective action if determined to be required.

10. The computer system of claim 9 wherein said processor executing said process further includes providing for accepting input from the user of a plurality of user specific settings and storing said plurality of user specific settings.

11. The computer system of claim 9 wherein said processor executing said process further includes providing for accepting input from the user of a plurality of user specific settings, and said plurality of user specific settings including a discomfort level, a recovery level, and a typing proficiency level.

12. The computer system of claim 9 wherein said processor executing said process further includes monitoring an output to said video display unit for changes to be viewed by the user.

13. The computer system of claim 9 wherein said corrective action is selected from a group including displaying a safe-tip, displaying an exercise, and scheduling a break.

14. At least one computer programmed to execute a process for monitoring and providing feedback to a user of a computer workstation, said process comprising:
providing for monitoring a plurality of inputs of the user from at least one input device selected from a group consisting of a keyboard and a mouse;
providing for determining a strain value, said strain value being a real-time value of strain induced in the user by operating the computer workstation;
providing for determining whether a corrective action is required based on said strain value; and
providing for taking said corrective action if determined to be required.

15. The process executed by said at least one computer of claim 14 further includes providing for accepting input from the user of a plurality of user specific settings and storing said plurality of user specific settings.

16. The process executed by said at least one computer of claim 14 further includes providing for accepting input from the user of a plurality of user specific settings and storing said plurality of user specific settings, and said plurality of user specific settings including a discomfort level, a recovery level, and a typing proficiency level.

17. The process executed by said at least one computer of claim 14 wherein said step of providing for determining said strain value further includes the step of providing for combining a keyboard strain value and a mouse strain value.

18. The process executed by said at least one computer of claim 14 wherein said corrective action is selected from a group including displaying a safe-tip, displaying an exercise, and scheduling a break.

19. Computer readable media tangibly embodying a program of instructions executable by a computer to perform a method of monitoring and providing feedback to a user of a computer workstation, said method comprising:
providing for accepting input of a plurality of user specific settings;
providing for storing said plurality of user specific settings;
providing for monitoring a plurality of inputs of the user from at least one input device selected from a group consisting of a keyboard and a mouse;
providing for determining a strain value, said strain value being a real-time value of strain induced in the user by operating the computer workstation; and
providing for determining whether a corrective action is required based on said strain value.

20. Media as in claim 19 further including providing for taking said corrective action if determined to be required.

21. Media as in claim 19 further including providing for taking said corrective action if determined to be required, said corrective action including at least one action selected from the group including displaying a safe-tip, displaying a warning, displaying an exercise, forcing the user to take a break.

22. Media as in claim 19 further including providing for sending an alert for reporting when said strain of the user exceeds a specified threshold.

23. Media as in claim 19 wherein said corrective action is selected from a group including displaying a safe-tip, displaying an exercise, and scheduling a break.

24. Media as in claim 19 wherein said method further includes providing for determining a keyboard strain value, said keyboard strain value used in determining said strain value.

25. A method in a computer system for monitoring and providing feedback to a user of a computer workstation, comprising the steps of:
determining a strain induced by working at the computer workstation by monitoring a plurality of inputs from the user, said plurality of inputs entered as a part of a work task of the user;
presenting an exercise to the user for reducing said strain, said step of presenting said exercise occurring when said strain is above a first specified value,
presenting a warning to the user for reducing said strain, said step of presenting said warning occurring when said strain is above a second specified value and below said first specified value, said second specified value being less than said first specified value; and
presenting a display to the user of one of a plurality of safe-tips, said step of presenting said display occurring when said strain is above a third specified value and below said second specified value, said third specified value being less than said second specified value.

26. The method of claim 25 wherein said step of presenting said exercise includes displaying said exercise such that a video display unit viewable by the user displays only information related to said step of presenting said exercise.

27. The method of claim 25 wherein said step of presenting said exercise includes displaying said exercise such that a video display unit viewable by the user displays only information related to said step of presenting said exercise, and further includes presenting an override to the user to exit said step of presenting said exercise.

28. The method of claim 25 wherein said step of presenting said exercise includes providing the user with a break from performing said work task.

29. The method of claim 25 wherein said step of determining said strain further includes combining a keyboard strain value and a mouse strain value.
